(19) United States
(12) Patent Application Publication
(10) Pub. No.: US 2002/0044108 A1
(43) Pub. Date: Apr. 18, 2002

(54) Plasma addressed liquid crystal display device

(76) Inventors: Kevin J. Ilcisin, Beaverton, OR (US); Thomas S. Buzak, Beaverton, OR (US)

Correspondence Address: John D. Winkelman, Tektronix, Inc., P.O. Box 500, Delivery Station 50-LAW, Beaverton, OR, 97077-0001, US

(21) Appl. No.: 09/970,537

(22) Filed: Oct. 3, 2001

Related U.S. Application Data
(60) Provisional application No. 60/241,471, filed on Oct. 18, 2000.

(51) Int. Cl. G09G 3/28

(52) U.S. Cl. 345/60

(57) ABSTRACT

A plasma addressed data storage or display device includes a channel structure defining multiple channels, a single plasma electrode in each channel, a cover sheet over the channel structure, ionizable gas in the channels, a layer of electro-optic material over the cover sheet, and an array of data drive electrodes over the layer of electro-optic material. A discharge is initiated in the active channel by controlling the potential difference between the single plasma electrode in the active channel and the data drive electrodes.

### CROSS-REFERENCE TO RELATED APPLICATION

This application claims the benefit of U.S. Provisional Application No. 60/241,471, filed Oct. 18, 2000.

### BACKGROUND OF THE INVENTION

This invention relates to a plasma addressed liquid crystal (PALC) device.

U.S. Pat. No. 5,077,553 discloses apparatus for addressing data storage elements. A practical implementation of the apparatus shown in U.S. Pat. No. 5,077,553 is illustrated schematically in FIG. 1 of the accompanying drawings.

The display panel shown in FIG. 1 comprises, in sequence from below, a polarizer 2, a lower substrate 4, ribs 6, a cover sheet 8 (commonly known as a microsheet), a layer 10 of electro-optic material, an array of parallel transparent data drive electrodes (only one of which, designated 12, can be seen in the view shown in FIG. 1), an upper substrate 14 carrying the data drive electrodes, and an upper polarizer 16. In the case of a color display panel, the panel includes color filters (not shown) between the layer 10 and the upper substrate 14. The panel may also include layers for improving viewing angle and for other purposes. The ribs 6 define multiple parallel channels 20 between the lower substrate and the cover sheet. The channels 20 are filled with an ionizable gas, such as helium. An anode 24 and a cathode 26 are provided in each of the channels 20. The channels 20 are orthogonal to the data drive electrodes and the region where a data drive electrode crosses a channel (when viewed perpendicularly to the panel) forms a discrete panel element 28. Each panel element can be considered to include elements of the layer 10 and the lower and upper polarizers 2 and 16. The region of the upper surface of the display panel that bounds the panel element constitutes a single pixel 30 of the display panel.

When the anode 24 in one of the channels is connected to a reference potential and a suitably more negative voltage is applied to the cathode 26 in that channel, the gas in the channel forms a plasma which provides a conductive path to the reference potential at the lower surface of the cover sheet 6. If a data drive electrode is at the reference potential, there is no significant electric field in the volume element of electro-optic material in the panel element at the crossing of the channel and the data drive electrode and the panel element is considered to be off, whereas if the data drive electrode is at a substantially different potential from the reference potential, there is a substantial electric field in that volume element of electro-optic material and the panel element is considered to be on.

It will be assumed in the following description, without intending to limit the scope of the claims, that the lower polarizer 2 is a linear polarizer and that its plane of polarization can be arbitrarily designated as being at 0° relative to a reference plane, that the upper polarizer 16 is a linear polarizer having its plane of polarization at 90°, and that the electro-optic material rotates the plane of polarization of linearly polarized light passing therethrough by an angle which is a function of the electric field in the electro-optic material. When the panel element is off, the angle of rotation is 90°; and when the panel element is on, the angle of rotation is zero.

The panel is illuminated from the underside by an extended light source 34 which emits unpolarized white light. A rear glass diffuser 18 having a scattering surface may be positioned between the light source and the panel in order to provide uniform illumination of the panel. The light that enters a given panel element from the source is linearly polarized at 0° by the lower polarizer 2 and passes sequentially through the channel member 4, the channel 20, the cover sheet 6, and the volume element of the electro-optic material toward the upper polarizer 16 and a viewer 32. If the panel element is off, the plane of polarization of linearly polarized light passing through the volume element of electro-optic material is rotated through 90°, and therefore the plane of polarization of light incident on the upper polarizer element is at 90°. The light is passed by the upper polarizer element and the pixel is illuminated. If, on the other hand, the panel element is on, the plane of polarization of the linearly polarized light is not changed on passing through the volume element of electro-optic material. The plane of polarization of light incident on the upper polarizer element is at 0° and therefore the light is blocked by the upper polarizer element and the pixel is dark. If the electric field in the volume element of electro-optic material is intermediate the values associated with the panel element being off and on, light is passed by the upper polarizer element with an intensity which depends on the electric field, allowing a gray scale to be displayed.

Typically, the reference potential to which the anode 24 is connected is a ground reference potential and the cathode is driven to a potential in the range −200 to −300 volts in order to initiate a discharge in a channel. The potential difference between the anode and a data drive electrode associated with the panel element being on is typically at least 50 volts; when the anode and a data drive electrode are at the same potential, the panel element is off.

The voltages that are applied to the cathode and the data drive electrodes typically vary in accordance with the waveforms shown in FIG. 2. The anode 24 (waveform A) is held at a reference potential level, which may be ground. To write data in a single line, the data drive electrodes (waveform B) are driven so that there is a voltage difference of up to about 80 volts between each data drive electrodes and the anode 24. The actual voltage to which a given data drive electrode is driven depends on the desired gray scale level of the pixel at the crossing of the data drive electrode and the channel. Generally, the polarity of the voltage applied to the data drive electrodes alternates on successive frames to eliminate DC offset effects in the liquid crystal. The cathode 26 (waveform C) is driven to a negative firing voltage V_{f}, which is typically in the range −150 to −500 volts in order to initiate a discharge in the channel, and is then held at a negative sustain voltage Vₛ, which is typically less negative than the firing voltage. Finally, the cathode returns to ground and the discharge is extinguished.

A discharge that is initiated in an ionizable gas between two electrodes that are both exposed to the gas is known as a DC discharge. The display panel shown in FIG. 1 employs a DC discharge. A discharge can be initiated in an ionizable gas even if at least one of the electrodes is electrically insulated from the ionizable gas. Such a discharge is known as an AC discharge. PALC panels have been proposed employing a hybrid AC/DC discharge, where only one electrode is isolated from the ionizable gas, and a pure AC discharge, where both electrodes are isolated from the ionizable gas.

Plasma discharge display panels have been manufactured employing an array of parallel row electrodes and an array of parallel column electrodes in crossing relationship with the array of row electrodes and spaced from the array of row electrodes with an ionizable gas between the two arrays of electrodes. A panel element is defined at each crossing of a row electrode and a column electrode. An image is displayed by selectively driving the row and column electrodes to initiate localized discharges at selected panel elements. If a discharge is initiated at a given panel element, that panel element is illuminated whereas if no discharge is initiated, the panel element is not illuminated.

It will be appreciated from the foregoing that the respective modes of operation of the plasma discharge display panel and the plasma addressed liquid crystal display panel are different, in that in the plasma display panel, the plasma serves as the light source whereas in the plasma addressed liquid crystal display panel, the plasma serves as a switch for controlling the electric field applied to the volume element of electro-optic material and hence whether the volume element of electro-optic material will transmit or block light from a light source external to the panel.

### SUMMARY OF THE INVENTION

In accordance with a first aspect of the invention there is provided a plasma addressed data storage or display device comprising a channel structure defining multiple channels, a single plasma electrode in each channel, a cover sheet over the channel structure, ionizable gas in the channels, a layer of electro-optic material over the cover sheet, and an array of data drive electrodes over the layer of electro-optic material.

In accordance with a second aspect of the invention there is provided a method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes, in a first operating cycle, controlling relative potentials of the data drive electrodes and the first and second plasma electrodes to initiate a discharge in the first channel without initiating a discharge in the second channel, and in a second operating cycle, controlling relative potentials of the data drive electrodes and the first and second plasma electrodes to initiate a discharge in the second channel without initiating a discharge in the first channel.

In accordance with a third aspect of the invention there is provided a method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes, in a first operating cycle, applying data voltages to the data drive electrodes respectively, driving the first plasma electrode to a sufficient negative potential relative to the data drive electrodes to initiate a discharge in the first channel while maintaining the second plasma electrode at a potential relative to the data drive electrodes such that no discharge is initiated in the second channel, and changing the potential of the first plasma electrode such as to reduce the potential difference between the first plasma electrode and the data drive electrodes to a level such that the discharge in the first channel is extinguished, and in a second operating cycle, applying data voltages to the data drive electrodes respectively, driving the second plasma electrode to a sufficient negative potential relative to the data drive electrodes to initiate a discharge in the second channel while maintaining the first plasma electrode at a potential relative to the data drive electrodes such that no discharge is initiated in the first channel, and changing the potential of the second plasma electrode such as to reduce the potential difference between the second plasma electrode and the data drive electrodes to a level such that the discharge in the second channel is extinguished.

In accordance with a fourth aspect of the invention there is provided a method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes, in a first operating cycle, applying data voltages to the data drive electrodes respectively, driving the first plasma electrode to potentials of alternating polarity and of sufficient magnitude relative to the data drive electrodes to initiate a discharge in the first channel while maintaining the second plasma electrode at a potential relative to the data drive electrodes that no discharge is initiated in the second channel, and placing the first plasma electrode at a potential relative to the potentials of the data drive electrodes such that the discharge in the first channel is extinguished, and in a second operating cycle, applying data voltages to the data drive electrodes respectively, driving the second plasma electrode to potentials of alternating polarity and of sufficient magnitude relative to the data drive electrodes to initiate a discharge in the second channel while maintaining the first plasma electrode at a potential relative to the data drive electrodes that no discharge is initiated in the first channel, and placing the second plasma electrode at a potential relative to the potentials of the data drive electrodes such that the discharge in the second channel is extinguished.

In accordance with a fifth aspect of the invention there is provided a method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes, placing the first plasma electrode at a first potential level, placing the second plasma electrode at a second potential level, which is positive relative to the first potential level, driving the data drive electrodes to a positive potential relative to the second potential level and is such that electric field created in the first channel due to potential difference between the data drive electrodes and the first plasma electrode is sufficient to initiate a discharge in the first channel and electric field created in the second channel due to potential difference between the data drive electrodes and the second plasma electrode is insufficient to initiate a discharge in the second channel, driving the data drive electrodes to data drive voltages, and driving the first plasma electrode to a potential that is negative relative to the data drive voltages and is such that the electric field between the data drive electrodes and the first plasma electrode is sufficient to sustain the discharge in the first channel.

### BRIEF DESCRIPTION OF THE DRAWINGS

For a better understanding of the invention, and to show how the same may be carried into effect, reference will now be made, by way of example, to the accompanying drawings, in which

FIG. 1 is a partial sectional view of a PALC display panel in accordance with the prior art,

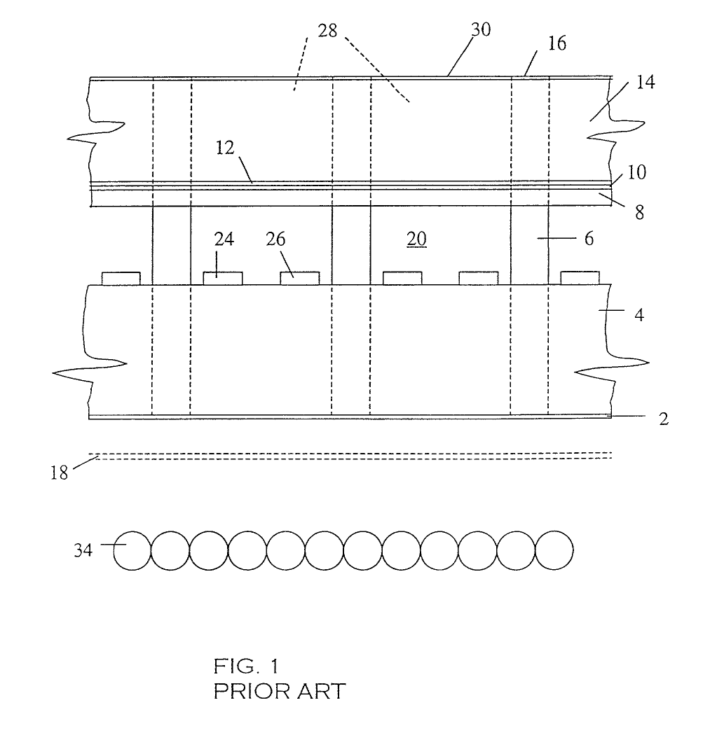

FIG. 2 is a partial sectional view of a PALC panel in accordance with the present invention,

FIG. 3 is a graph illustrating a first mode of operation of a PALC panel in accordance with the present invention, and

FIG. 4 is a graph illustrating a second mode of operation of a PALC panel in accordance with the present invention.

In the several figures of the drawings, like reference numerals designate like or corresponding components.

In this specification, words of orientation and position, such as upper and lower, are used to establish orientation and position relative to the drawings and are not intended to be limiting in an absolute sense. Thus, a surface that is described as upper in the specification may correspond, in a practical implementation of the invention, to a lower surface or a vertical surface, which is neither upper nor lower.

### DETAILED DESCRIPTION

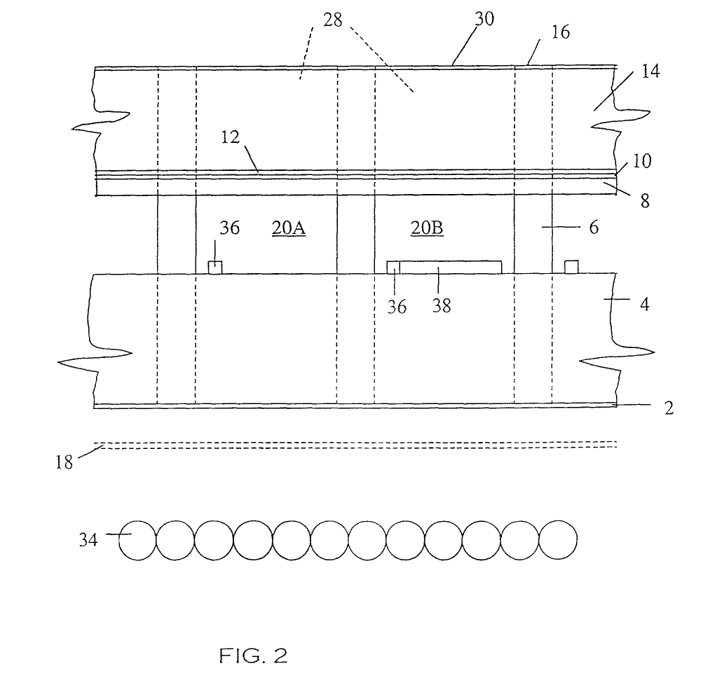

FIG. 2 illustrates a plasma addressed liquid crystal display panel in which each channel 20 contains a single plasma electrode. As shown in the case of the channel 20A, the plasma electrode may be a metal strip 36 exposed to the ionizable gas in the plasma channel, or as in the case of the channel 20B, it may be of composite structure including a metal strip 36 and a strip 38 made of a transparent conductive material, such as ITO. Generally, the strip 36, which is opaque, should be as narrow as possible in order to maximize the aperture of the channel. In the case of the composite electrode structure shown in the channel 20B, the strip 38 of transparent conductive material increases the effective area of the electrode without significantly reducing the aperture of the channel. In either case, the plasma electrode may be provided with a coating (not shown) of dielectric material to isolate the electrode from the ionizable gas in the channel. Preferably, a coating of a material having a high coefficient of secondary emission is provided over the coating of dielectric material. In the case of the composite electrode structure shown in the channel 20B, the dielectric material and the electron emissive material should be transparent, and in this case the preferred electron emissive material is magnesium oxide.

In operation of the plasma addressed device shown in FIG. 2, a discharge is initiated in the active channel by holding the plasma electrode in that channel at a first potential and then increasing the potential difference between the data drive electrodes and the plasma electrode in the active channel to increase the electric field in the active channel to a sufficient level to initiate the discharge. The plasma electrodes in the inactive channels are held at a second potential that is sufficiently close to the potentials applied to the data drive electrodes that a discharge will not be initiated in the inactive channels.

Since the data drive electrodes are isolated from the ionizable gas in the channel, the discharge that is initiated in the active channel is an AC discharge. In the case of the plasma electrode being isolated from the ionizable gas by dielectric material, the discharge is a pure AC discharge whereas in the case of the plasma electrode being exposed to the ionizable gas, as shown in FIG. 2, the discharge is a hybrid AC/DC discharge.

Proper operation of a plasma addressed device requires that a layer of charged particles be present on the underside of the cover sheet when the plasma in the channel is extinguished. This in turn requires that there be a sufficient charge in the channel just before the plasma is extinguished. Several different drive waveforms can be used to create sufficient charge in the channel for proper operation. 3, the waveform applied to a data drive electrode is the same as that for a typical DC PALC device and is influenced only by the desired state of the panel element at the crossing of the data drive electrode and the active channel. The data drive electrode is driven to a voltage up to about 80 volts from ground (positive and negative on alternate frames), as in the case of the conventional PALC panel. The signal applied to the plasma electrode in the active channel is either strobed negative once to initiate the discharge or it can include multiple pulses of alternating polarity. The number of pulses would typically be less than ten. In either case, it is important to ensure that the charge density in the channel when the discharge is extinguished is sufficient to provide a suitable layer of charged particles on the underside of the cover sheet. Finally, the plasma electrode is grounded to extinguish the discharge while the data drive electrode is held at the appropriate voltage for writing the pixel to the desired state.

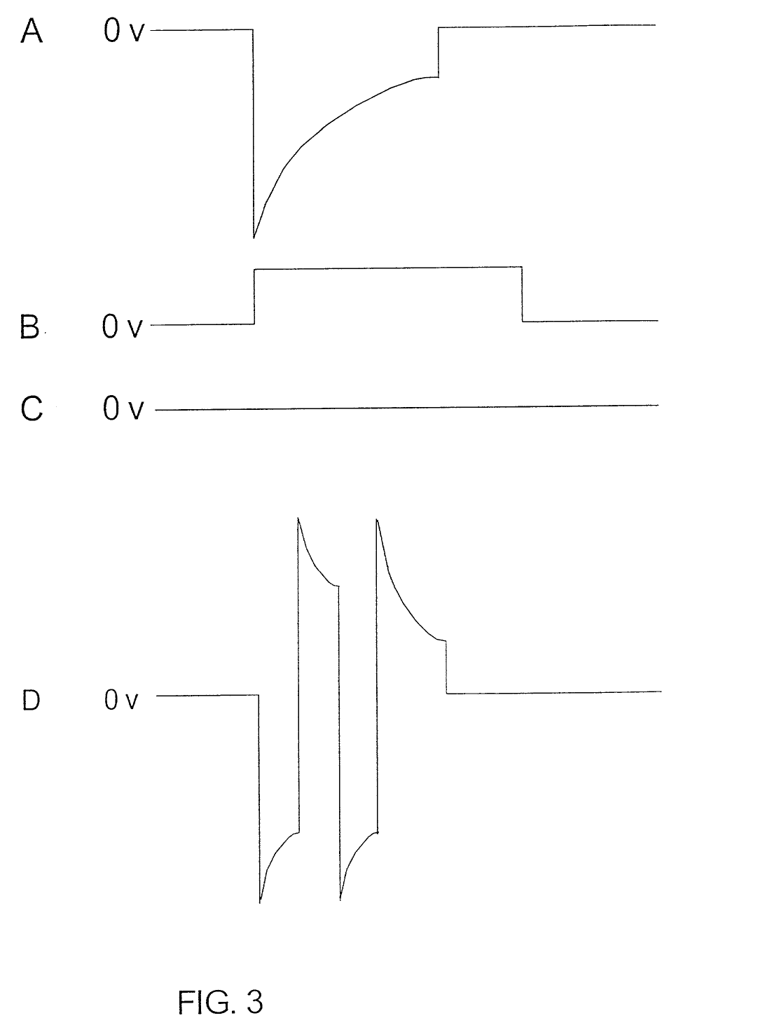

Referring to FIG. 3, waveform A represents the voltage that is applied to the plasma electrode in the channel that is currently addressed, waveform B represents the signal that is applied to a given data drive electrode when it is desired that the panel element at the crossing of the given data drive electrode and the active channel should be on and waveform C represents the voltage signal that is applied to a given data drive electrode when the panel element at the crossing of the given data drive electrode and the active channel is to be off. The difference between the peak negative voltage applied to the plasma electrode, shown in waveform A, and the least positive voltage applied to the data drive electrodes, as shown in waveforms B and C, is sufficient to initiate a discharge in the channel. The discharge does not contribute significantly to the light emitted by the panel.

Waveform D shows an alternative waveform applied to the plasma electrode, illustrating a sequence of pulses of alternating polarity having the purpose of building up charge in the channel so that there will be sufficient surface charge on the underside of the cover sheet just before the plasma is extinguished. The difference between the peak positive and negative voltages applied to the plasma electrode and the voltages applied to the data drive electrodes is sufficient to initiate a discharge on each pulse.

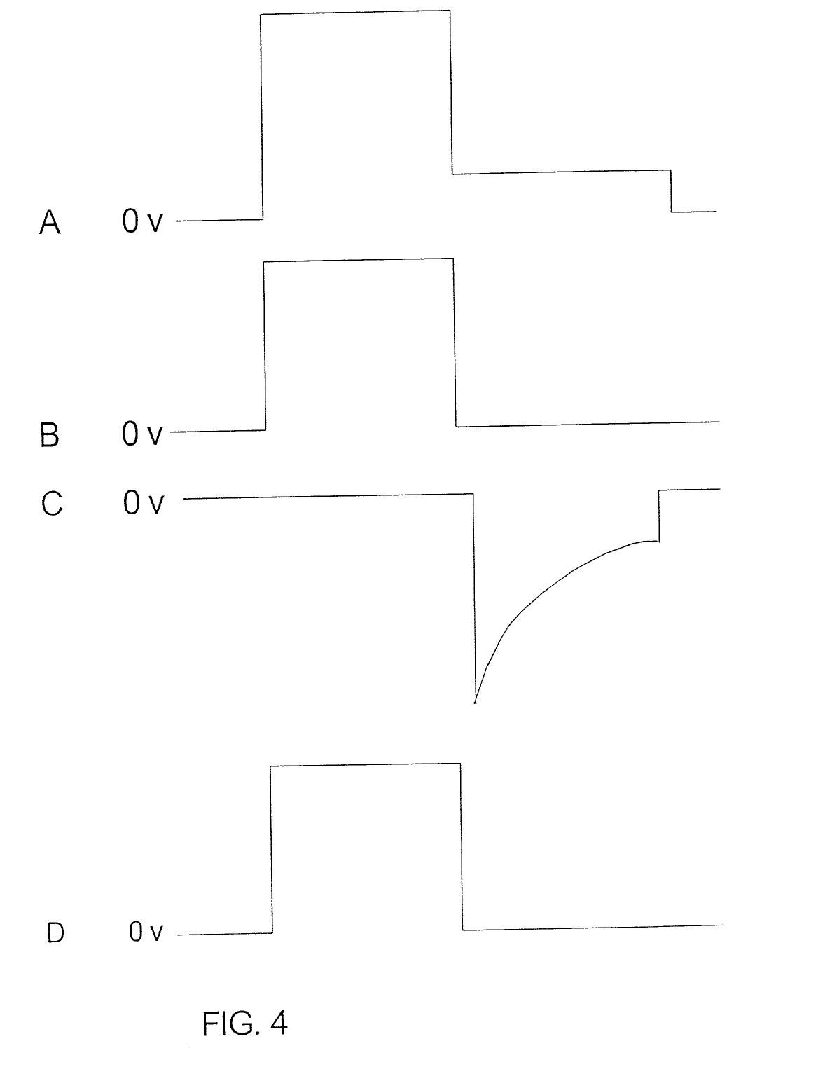

In accordance with a second approach, which is illustrated in FIG. 4, the voltages applied to the data drive electrodes are used to define both the high voltage potentials for initiating the discharge and the data potentials for controlling the state of the panel element. In one example, the data drive electrodes are first driven to a positive potential while the plasma electrode in the active channel is left at ground and the plasma electrodes in the other channels are driven to a sufficient positive potential to inhibit firing. Each data drive electrode is then returned either to ground or to the required data voltage and the plasma electrode in the active channel is driven to a potential level sufficient to effect a second discharge. This potential may be either positive or negative relative to the data drive electrodes. The potential difference between the data drive electrodes and the plasma electrode in the active channel is sufficient to initiate the second discharge whereas the potential difference between the data drive electrodes and the plasma electrodes in the other channels is not sufficient to initiate a discharge.

Curve A in FIG. 4 represents the waveform of the voltage applied to a given data drive electrode when it is desired that the panel element at the crossing of given data drive electrode and the active channel should be on and curve B represents the waveform of the voltage signal that is applied to a given data drive electrode when it is desired that the panel element at the crossing of the data drive electrode and the active channel should be off. Curve C shows the waveform of the voltage applied to the plasma electrode in the active channel and curve D shows the waveform of the voltage applied to the plasma electrode in an inactive channel. Initially, all data drive electrodes are driven to a sufficiently high voltage relative to the plasma electrode in the active channel to initiate a discharge in that channel, whereas the difference between the voltage of the data drive electrodes and the plasma electrodes in the other channels is insufficient to initiate a discharge in those channels. Subsequently, the data drive electrodes are driven to the voltages that are required to establish the states of the various panel elements, curve A showing the waveform for a panel element that is on and curve B showing the waveform for a panel element that is off. The plasma electrodes in the inactive channels are returned to a low voltage, such that the voltage difference between the plasma electrodes in those channels and the data drive electrodes is not sufficient to initiate a discharge. The plasma electrode in the active channel is driven to large negative voltage such that the voltage difference between that plasma electrode and the data drive electrodes is sufficient to initiate a second discharge.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes,
in a first operating cycle, controlling relative potentials of the data drive electrodes and the first and second plasma electrodes to initiate a discharge in the first channel without initiating a discharge in the second channel, and
in a second operating cycle, controlling relative potentials of the data drive electrodes and the first and second plasma electrodes to initiate a discharge in the second channel without initiating a discharge in the first channel.

2. A method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes,
in a first operating cycle,
applying data voltages to the data drive electrodes respectively,
driving the first plasma electrode to a sufficient negative potential relative to the data drive electrodes to initiate a discharge in the first channel while maintaining the second plasma electrode at a potential relative to the data drive electrodes such that no discharge is initiated in the second channel, and
changing the potential of the first plasma electrode such as to reduce the potential difference between the first plasma electrode and the data drive electrodes to a level such that the discharge in the first channel is extinguished, and in a second operating cycle,
applying data voltages to the data drive electrodes respectively,
driving the second plasma electrode to a sufficient negative potential relative to the data drive electrodes to initiate a discharge in the second channel while maintaining the first plasma electrode at a potential relative to the data drive electrodes such that no discharge is initiated in the first channel, and
changing the potential of the second plasma electrode such as to reduce the potential difference between the second plasma electrode and the data drive electrodes to a level such that the discharge in the second channel is extinguished.

3. A method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes,
in a first operating cycle,
applying data voltages to the data drive electrodes respectively,
driving the first plasma electrode to potentials of alternating polarity and of sufficient magnitude relative to the data drive electrodes to initiate a discharge in the first channel while maintaining the second plasma electrode at a potential relative to the data drive electrodes that no discharge is initiated in the second channel, and
placing the first plasma electrode at a potential relative to the potentials of the data drive electrodes such that the discharge in the first channel is extinguished, and in a second operating cycle,
applying data voltages to the data drive electrodes respectively,
driving the second plasma electrode to potentials of alternating polarity and of sufficient magnitude relative to the data drive electrodes to initiate a discharge in the second channel while maintaining the first plasma electrode at a potential relative to the data drive electrodes that no discharge is initiated in the first channel, and
placing the second plasma electrode at a potential relative to the potentials of the data drive electrodes such that the discharge in the second channel is extinguished.

4. A method of operating a plasma addressed data storage or display device that comprises a channel structure defining at least first and second channels, first and second plasma electrodes in the first and second channels respectively, a cover sheet over the channel structure, ionizable gas in the channels, a layer of electro-optic material over the cover sheet and an array of data drive electrodes over the layer of electro-optic material, wherein the method includes,
placing the first plasma electrode at a first potential level,
placing the second plasma electrode at a second potential level, which is positive relative to the first potential level,
driving the data drive electrodes to a positive potential relative to the second potential level and is such that electric field created in the first channel due to potential difference between the data drive electrodes and the first plasma electrode is sufficient to initiate a discharge in the first channel and electric field created in the second channel due to potential difference between the data drive electrodes and the second plasma electrode is insufficient to initiate a discharge in the second channel,
driving the data drive electrodes to data drive voltages, and
driving the first plasma electrode to a potential that is negative relative to the data drive voltages and is such that the electric field between the data drive electrodes and the first plasma electrode is sufficient to sustain the discharge in the first channel.
